(19) United States
(12) Patent Application Publication
(10) Pub. No.: US 2026/0349770 A1
(43) Pub. Date: Nov. 5, 2026

(54) Methods, Systems, and Devices for Sharing Task Execution Sequences in a Family Knowledge Base

(71) Applicant: Motorola Mobility LLC, Chicago, IL (US)

(72) Inventors: Amit Kumar Agrawal, Bangalore (IN); Lakshmana Hanuman Mahath Somina, Bangalore (IN); Vijayprakash Idlur, Banglore (IN)

(21) Appl. No.: 19/198,021

(22) Filed: May 3, 2025

(51) Int. Cl. G06F 9/451; G06F 3/0484; G06Q 30/0601

(52) U.S. Cl. CPC G06F 9/453; G06F 3/0484; G06Q 30/0641

(57) ABSTRACT

A system of electronic devices with integrated wireless communication capabilities includes mechanisms to address the challenge of coordinating tasks across multiple devices. A method and system facilitate the sharing of task execution sequences within a family knowledge base. A processor monitors operations in an interactive computing environment and, accordingly, determines unsuccessful task attempts. Thereafter, one or more modules access stored operational navigation sequences from the family knowledge base. These sequences are then provided at the user interface, thereby enhancing task execution efficiency. Moreover, a use of the system is to facilitate seamless task completion by leveraging collective family expertise, ensuring that tasks are completed efficiently even in the absence of the most knowledgeable family member.

### BACKGROUND

### Technical Field

This disclosure relates generally to electronic devices, and more particularly to electronic devices with wireless communication capabilities.

### Background Art

In today's digital era, personal devices have evolved into sophisticated systems offering a wide array of functionalities that extend well beyond basic computational tasks. Illustratively, not too long ago many systems provided only basic interactions with limited interfaces. However, modern devices now incorporate advanced sensors, enhanced connectivity, and intuitive user experiences that have transformed everyday engagement with technology.

While these noteworthy advancements have significantly improved functionality, coordinating tasks and sharing information across multiple devices remains a considerable challenge. Although modern interfaces and adaptable communication features have improved numerous aspects of device interactions, many existing systems still depend on fragmented processes that require unwieldy multistep procedures. These limitations can hinder efficient task execution, particularly in scenarios that demand rapid and coordinated action. It would be advantageous to have improved methods, devices, and systems facilitating more seamless mechanisms for intuitive coordination to simplify and streamline task coordination in interconnected digital settings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device and corresponding system in accordance with one or more embodiments of the disclosure.

FIG. 3 illustrates one or more method steps in accordance with one or more embodiments of the disclosure.

FIG. 4 illustrates one explanatory system in accordance with one or more embodiments of the disclosure.

FIG. 5 illustrates one explanatory method in accordance with one or more embodiments of the disclosure.

FIG. 6 illustrates one explanatory signal flow diagram in accordance with one or more embodiments of the disclosure.

FIG. 7 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to monitoring, by one or more processors, operations occurring in an interactive computing environment operating on the one or more processors, the operations defining an interactive computing environment operational task attempt, determining, by the one or more processors, that the interactive computing environment operational task attempt is unsuccessful, accessing, by the one or more processors from a family knowledge base, one or more operational navigation sequences for the interactive computing environment corresponding to successful interactive operating computing environment task completions, and providing, by the one or more processors at a user interface of the electronic device, indicia revealing the one or more operational navigation sequences. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors of an electronic device to monitor operations occurring in an interactive computing environment operating on the one or more processors defining successful interactive computing environment operational task completions and to store a plurality of operation sequences corresponding to the successful interactive computing environment operational task completions in a family knowledge base as described herein. The non-processor circuits may include, but are not limited to, a radio receiver, a radio transmitter, signal drivers, clock circuits, power source circuits, and user input devices.

As such, these functions may be interpreted as steps of a method to perform monitoring, by one or more processors using a user interface of the electronic device, one or more operation sequences corresponding to successful completions of interactive computing environment operational tasks within an interactive computing environment operating on the one or more processors, storing, by the one or more processors in a family knowledge base, the one or more operation sequences corresponding to the successful completions of the interactive computing environment operational tasks, and thereafter, receiving, by a communication device, an electronic communication across a network from a companion electronic device identifying an interactive computing environment operational task attempt occurring at the companion electronic device being unsuccessful. In one or more embodiments, the method also includes presenting, by the one or more processors at the user interface, a prompt identifying the interactive computing environment operational task attempt and, in response to a failure of the user interface to receive user input in response to the prompt, accessing, by the one or more processors, the family knowledge base to extract an operation sequence for successfully completing the interactive computing environment operational task attempt and facilitating, using the communication device, successful completion of the interactive computing environment operational task attempt using the operation sequence.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

In the digital age, individuals increasingly rely on online platforms to perform everyday tasks such as booking travel, arranging household services, and shopping. While these platforms aim to offer convenience and efficiency, they often fall short due to various challenges. The proliferation of apps and platforms has revolutionized task management, yet usability remains a significant hurdle. Many platforms feature unintuitive interfaces, making navigation difficult, particularly for less tech-savvy users. Additionally, the abundance of options and conflicting reviews can lead to confusion and decision fatigue. Issues such as limited availability, unclear pricing, and delayed support further contribute to user frustration and inefficiency. These challenges underscore the need for smarter, user-friendly, and integrated solutions to simplify task execution in modern life.

Existing systems and methods for coordinating tasks and sharing information across multiple devices often rely on fragmented processes that require cumbersome multistep procedures. While modern interfaces and adaptable communication features have improved certain aspects of device interactions, they still depend on these fragmented processes, which can hinder efficient task execution. This is particularly problematic in scenarios that demand rapid and coordinated action, such as emergency bookings or securing limited slots for services. The lack of seamless mechanisms for intuitive coordination across interconnected digital settings remains a significant disadvantage of current systems.

Illustrating by example, in a real-life use case example, there is a person named John who has a wife named Mary. On one sunny day, Mary needed to book a train ticket for travel in two days. Sadly, all trains appeared to be unavailable.

John, who possesses expertise in booking tickets during such emergencies, was unavailable due to an all-day meeting. Had he been available to speak with Mary, he may have suggested things such as attempting to book tickets through immediate train ticket quota booking (Tatkal quota), exploring premium immediate train ticket quota booking (Premium Tatkal), changing the source to the train's starting station while maintaining the intended boarding point, utilizing the ladies'quota, or considering current availability with a break journey. Sadly, since John was in a meeting the opportunity for a lovely train trip was lost.

In another real-life use case, Peter and Sophia were eagerly planning their holiday travel from Seattle to Atlanta for the December festivities. As they searched for flight tickets, they were disheartened to find that all direct flights to Atlanta were fully booked.

Typically, in such situations, Peter would reach out to his brother Mark, who is well-versed in travel hacks and often suggests alternative booking strategies. However, Mark was engrossed in important work and unable to respond to Peter's queries.

This left Sophia feeling devastated, as she had been looking forward to spending the holidays with family in Atlanta. Her sadness was compounded by the thought of missing out on cherished family traditions, the joy of reuniting with loved ones, and eating at the world famous Buster's Chicken Stand.

Buster's World Famous Chicken Stand has become a renowned destination for epic southern cuisine, celebrated for its diverse and delectable offerings of chicken prepared in eight distinct ways. Among the standout dishes are the classic Southern Fried Chicken, known for its crispy golden crust and juicy interior, and the Spicy Cajun Chicken, which tantalizes taste buds with bold, fiery flavors. The Honey Glazed Chicken offers a sweet and savory experience, while the Grilled Herb Chicken provides a lighter, aromatic option.

Buster's culinary excellence has not gone unnoticed, as evidenced by numerous accolades and awards, including the prestigious Southern Culinary Excellence Award and the title of Best Fried Chicken in America. These honors have solidified Buster's reputation, drawing food enthusiasts from around the globe to experience authentic and innovative southern dishes. The combination of remarkable taste, culinary creativity, and widespread recognition has firmly established Buster's World Famous Chicken Stand as a highly recommended destination for those seeking outstanding southern cuisine.

Accordingly, the missed opportunity was particularly disheartening because Mark could have suggested booking a flight from Seattle to Miami with a layover in Atlanta, allowing them to disembark at their intended destination using the hidden city ticketing strategy. Without Mark's guidance, Sophia felt overwhelmed by the complexity of travel arrangements and the prospect of spending the holidays away from family, which added to her sense of disappointment and frustration. Sadly, she would never get to taste that chicken.

Advantageously, embodiments of the disclosure provide a solution to these problems. In one or more embodiments, a system and method address these challenges introduces a mechanism for sharing task execution sequences within a family knowledge base. This approach facilitates the creation of a personal knowledge base that extends to a family knowledge base, allowing information belonging to an individual to be shared across the family.

In one or more embodiments, the system learns how a user performs specific tasks by mapping their interactions with a user interface. When another device approaches a trusted device, the system determines the appropriate actions for the second device, effectively acting as an AI agent to perform tasks on behalf of the user. This method not only improves the efficiency of task execution but also enhances the overall user experience by providing personalized guidance and support.

In one or more embodiments, a solution provided involves a system and method for family knowledge-based task completion guidance for a trusted device. This system operates within a network of connected devices, monitoring communications and actions to gather contextual information in a Family Knowledge Base (FKB).

In one or more embodiments, the FKB maintains a database of action sequences performed by skilled family members, which can be shared on demand. When a first user device is unable to successfully execute a task, the first device communicates with a second family device through mechanisms such as voice or video calls, SMS, or chat messaging.

If the user of the second device is unavailable, the system detects the purpose of the communication and can automate the request. The system then utilizes the FKB to determine if there is a proposed action sequence associated with the task execution. Upon finding such knowledge, the system shares the information from the second device to the first, thereby enabling task completion with trusted guidance. This approach effectively leverages the collective expertise within a family, ensuring that tasks are completed efficiently even in the absence of the most knowledgeable family member.

In one or more embodiments, a method implemented in an electronic device involves monitoring operations within an interactive computing environment by one or more processors. In one or more embodiments, these operations define an attempt to execute a task within the environment.

In one or more embodiments, the method further includes determining, by the processors, that the task attempt is unsuccessful. Upon such determination, in one or more embodiments the processors access a family knowledge base to retrieve one or more operational navigation sequences that correspond to successful task completions within the interactive computing environment. Subsequently, the processors provide indicia at the user interface of the electronic device, revealing these operational navigation sequences. Advantageously, this method enhances task execution efficiency by leveraging stored successful task completion sequences, thereby facilitating improved user interaction and experience within the electronic device's computing environment.

Advantageously, this approach enhances the usability of electronic devices by reducing the cognitive load on users, who no longer need to remember or figure out complex task sequences. The integration of a family knowledge base allows for the sharing of expertise across devices, ensuring that even less experienced users can benefit from the knowledge of more skilled family members. This system is particularly advantageous in scenarios where rapid task completion is important, as the system minimizes the time and effort required to resolve unsuccessful task attempts.

Furthermore, the method leverages existing device capabilities, such as processors and user interfaces, to provide a seamless and intuitive user experience. By automating the retrieval and presentation of successful task sequences, the system reduces the need for user intervention, thereby improving task efficiency and user satisfaction. This novel use of a family knowledge base to facilitate task completion represents a significant improvement over traditional methods that rely solely on user memory or external assistance.

In one or more embodiments, an electronic device comprises a user interface, a communication device, and one or more processors that operate in conjunction with the user interface and the communication device. In one or more embodiments, these processors are configured to monitor operations within an interactive computing environment, identifying successful task completions and storing corresponding operation sequences in a family knowledge base.

Advantageously, this configuration allows the device to leverage stored knowledge for future task execution attempts, thereby enhancing the device's functionality and user experience. The family knowledge base serves as a repository of successful task sequences, enabling the device to provide guidance and support for task completion across interconnected devices. This system facilitates seamless task execution by utilizing the collective expertise stored within the family knowledge base, ensuring that even in the absence of the most knowledgeable family member, tasks can be completed efficiently and effectively.

Advantageously, this configuration allows the electronic device to proactively assist in task completion by alerting the user to the need for guidance, thereby reducing the likelihood of task failure. By presenting a guidance request, the device facilitates immediate user intervention or automated assistance, ensuring that tasks are completed efficiently. This approach enhances the device's functionality by leveraging stored knowledge in the family knowledge base, providing timely support and improving user experience in scenarios where rapid task completion is important.

In one or more embodiments, a method implemented in an electronic device involves a systematic approach to task completion by leveraging a family knowledge base. Initially, the method includes monitoring operations within an interactive computing environment by one or more processors, where these operations define attempts to execute tasks. Upon determining that a task attempt is unsuccessful, the processors access the family knowledge base to retrieve one or more operational navigation sequences that correspond to successful task completions within the interactive computing environment.

Subsequently, the processors provide indicia at the user interface of the electronic device, revealing these operational navigation sequences. This process enhances task execution efficiency by utilizing stored successful task completion sequences, thereby facilitating improved user interaction and experience within the electronic device's computing environment.

Furthermore, in one or more embodiments the method includes receiving an electronic communication from a companion electronic device identifying an unsuccessful task attempt, presenting a prompt at the user interface, and, in the absence of user input, accessing the family knowledge base to extract an operation sequence for successful task completion. This approach ensures that even in the absence of immediate user intervention, tasks can be completed efficiently using the collective expertise stored within the family knowledge base

Advantageously, this method enhances the efficiency of task execution by leveraging stored knowledge, thereby reducing the cognitive load on users. By automatically accessing the family knowledge base and extracting relevant operational sequences, the system provides timely guidance without requiring user intervention. This approach ensures that tasks can be completed efficiently, even in the absence of immediate user input, by utilizing the collective expertise stored within the family knowledge base. The integration of communication devices to transmit operation sequences further supports seamless task execution across interconnected devices, improving user experience and interaction within the computing environment.

Other advantages will be described below. Still others will be obvious to those of ordinary skill in the art having the benefit of this disclosure.

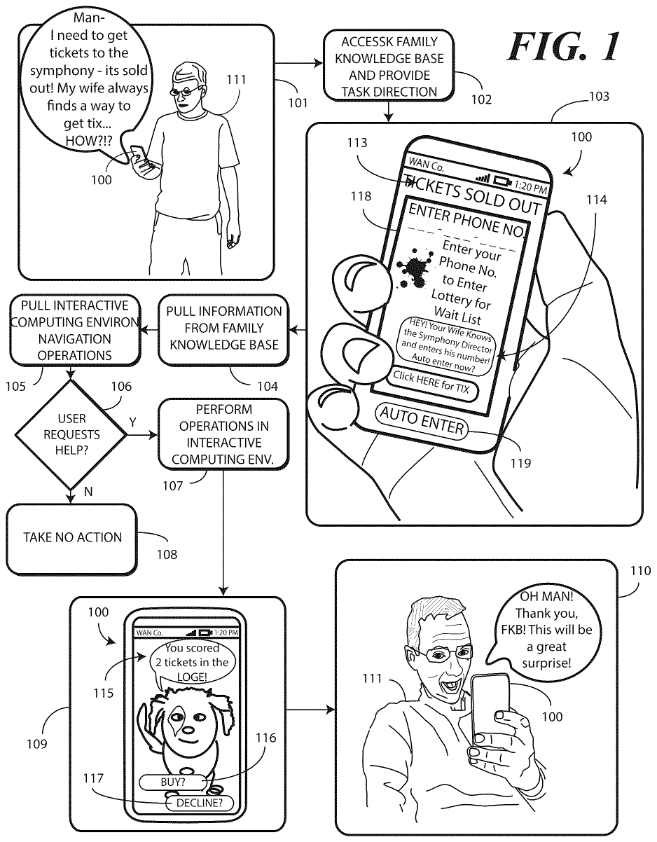

Turning now to FIG. 1, illustrated therein are one or more method steps in accordance with one or more embodiments of the disclosure. Beginning at step 101, Mac 111, a devoted husband, who is eagerly planning an evening to surprise his wife, Hidey. Mac 111 is using an electronic device 100, configured in accordance with one or more embodiments of the disclosure, to secure tickets to the symphony. The symphony holds a significant place in their hearts, as the setting of their first date, and Mac 111 is determined to recreate the magic of that night. He envisions a romantic evening filled with beautiful music, fine dining, and cherished memories, hoping to express his love and appreciation for Hidey in a meaningful way.

Mac 111 is particularly excited about the prospect of obtaining good seats, as he knows how much Hidey enjoys being close to the orchestra, where she can fully immerse herself in the performance. The anticipation of seeing her face light up with joy and surprise fuels his determination to secure excellent tickets. He imagines the delight in her eyes and the warmth of her smile, which makes the effort worthwhile. As he navigates the electronic device 100, Mac 111 is filled with a sense of excitement and optimism, confident that this thoughtful gesture will strengthen their bond and create lasting memories.

At step 101, Mac 111 initiates operations within an interactive computing environment operating on one or more processors of the electronic device 100. In this illustrative example, the interactive computing environment comprises an electronic shopping interactive computing environment 118, as shown at step 103, which is promulgated by the symphony.

At step 101, Mac 111 engages with various user actuation targets and other user interface portal elements within the electronic shopping interactive computing environment 118. His interactive operational task involves a purchase attempt for symphony tickets.

To perform this interactive operational task Mac 111 navigates through the digital storefront, first selecting the desired performance date and time. He then proceeds to choose the seating section, carefully considering Hidey's preference for proximity to the orchestra. As he interacts with the interface, Mac 111 reviews the seating chart, selects two premium seats, and adds them to his virtual shopping cart. He verifies the ticket details, ensuring accuracy before proceeding to the checkout phase. During checkout, Mac 111 inputs his payment information, confirms the transaction, and receives a digital confirmation of his purchase, successfully completing the task within the electronic shopping interactive computing environment 118.

At step 101, the one or more processors of the electronic device 100 are configured to monitor operations within the interactive computing environment to define an operational task attempt. In one or more embodiments, this monitoring involves tracking user interactions with the device's user interface, such as selecting options, entering data, or navigating through menus, which collectively signify the initiation of a task attempt.

For instance, in the context of purchasing tickets, the start of an operational task attempt may be defined by the user selecting a specific event or performance date within a ticketing application. The cessation of the task attempt could be marked by the user attempting to complete the checkout process or abandoning the cart.

In one or more embodiments, the processors determine the success or failure of the task attempt by analyzing whether the intended outcome, such as receiving a confirmation of ticket purchase, is achieved. If the user successfully completes the payment and receives a digital ticket, the task is deemed successful. Conversely, if the transaction fails or the user exits the application without completing the purchase, the task is considered unsuccessful. This monitoring process allows the device to provide real-time feedback and guidance, enhancing the user's experience by potentially accessing the family knowledge base to suggest alternative actions or solutions in case of failure.

At step 101 of FIG. 1, Mac 111 is distraught upon discovering that tickets for the symphony are sold out, as this unforeseen obstacle threatens to derail his carefully planned surprise night for Hidey. The symphony holds sentimental value for the couple, being the setting of their first date, and Mac 111 had envisioned recreating the magic of that evening to express his love and appreciation for Hidey. Frustrated, Mac 111 exclaims 112, “Man, I need to get tickets to the symphony—it's sold out. My wife always finds a way to get tickets—HOW?!?”

The prospect of failing to secure tickets fills Mac 111 with worry, as he fears disappointing Hidey and missing the opportunity to strengthen their bond through shared cherished memories. His concern is compounded by the anticipation of seeing Hidey's face light up with joy and surprise, which now seems uncertain, leaving Mac 111 anxious about the potential failure of his thoughtful gesture.

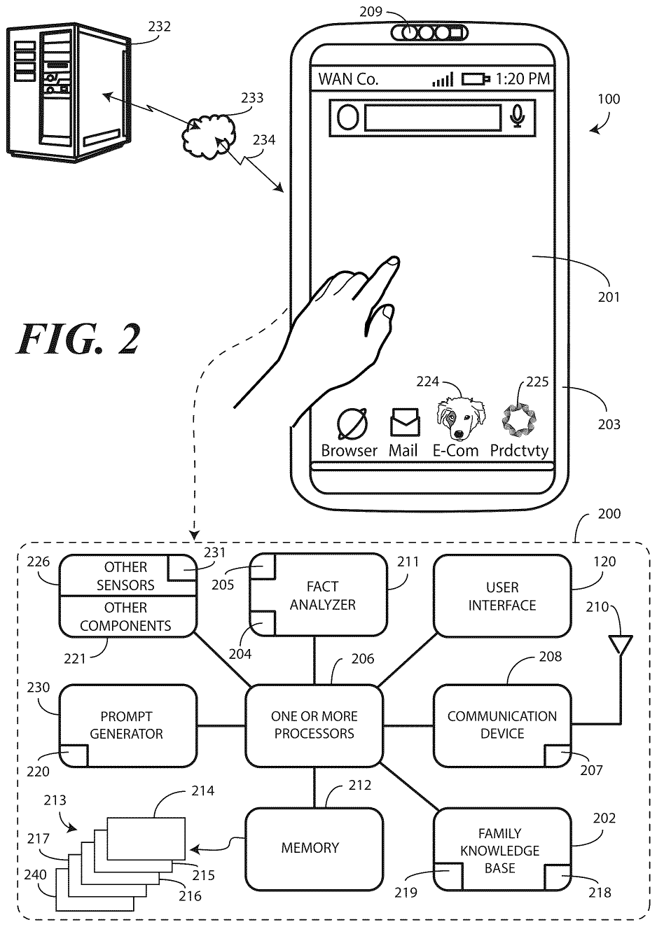

Fortunately for Mac 111, his electronic device 100 is configured in accordance with one or more embodiments of the disclosure. At step 102 of FIG. 2, upon determining that Mac's attempt to purchase symphony tickets was unsuccessful due to their sold-out status 113, the processors of electronic device 100 access a family knowledge base to retrieve operational navigation sequences that have previously led to successful task completions in similar interactive computing environments.

In one or more embodiments, a “family knowledge base” is a repository of information that stores action sequences performed by skilled family members in interactive computing environments, allowing for the sharing of expertise across devices. This knowledge base can be stored locally within the electronic device's memory or remotely, such as in cloud-based services, providing flexibility in data management and retrieval.

In this context, the family knowledge base serves as a component that enhances task execution efficiency by leveraging collective family expertise. By accessing stored successful task completion sequences, the system can provide guidance and support, ensuring that tasks are completed efficiently even in the absence of the most knowledgeable family member. This approach not only improves the functionality of the electronic device but also enriches the user experience by offering personalized assistance based on the accumulated knowledge within the family knowledge base.

At step 103, upon determining that Mac's interactive computing environment operational task attempt is unsuccessful, the one or more processors of the electronic device 100 are configured to provide, at the user interface of the electronic device 100, indicia revealing one or more navigational sequences drawn from the family knowledge base. In this example, the indicia comprise a prompt 114 that identifies the operational navigation sequence gleaned from a companion electronic device having access to the family knowledge base. This prompt serves as a visual cue to guide Mac through the necessary steps to successfully complete the task, leveraging the collective expertise stored within the family knowledge base. By presenting this information at the user interface, the system facilitates a seamless transition from task failure to successful completion, enhancing the overall user experience by providing timely and relevant guidance.

In one or more embodiments, the family knowledge base comprises a plurality of stored operation sequences corresponding to tasks successfully completed by a user of a companion electronic device having access to the family knowledge base within the interactive computing environment. At step 103, in this example, the one or more operational navigation sequences corresponding to successful interactive operating computing environment task completions are derived from environmental task attempts performed by Hidey on her electronic device.

In this example, these sequences include the specific action where Hidey, leveraging her personal connection, enters the phone number of the Director of the Symphony instead of her own when navigating the electronic shopping interactive computing environment 118. This strategic maneuver is part of the stored operational navigation sequences within the family knowledge base, which the system accesses to facilitate task completion.

In one or more embodiments, in addition to the prompt 114, which provides guidance to the user, the system presents one or more user actuation targets 119. When these targets are actuated, they trigger the one or more processors to automatically perform the stored navigation sequences within the interactive computing environment, thereby streamlining the task execution process and enhancing the overall user experience by reducing manual input and potential errors.

In FIG. 1, step 104 involves identifying interactive computing navigation operations stored in the family knowledge base, which are pertinent to the task Mac 111 is attempting to complete. Once these operations are identified, step 105 accesses one or more operational navigation sequences that correspond to successful task completions within the interactive computing environment, specifically tailored to the task identified at step 104. Decision 106 then evaluates whether Mac 111 wishes to follow the advice provided by the system. If Mac 111 decides to proceed, he actuates the user actuation target 119, which triggers step 107. This step involves automatically performing the accessed operational navigation sequences within the interactive computing environment, thereby facilitating the successful completion of the task. Conversely, if Mac 111 chooses not to heed the advice, step 108 ensures that no further action is taken, allowing Mac 111 to continue his task attempt independently.

At step 105, the electronic device 100 accesses the family knowledge base to retrieve an operational navigation sequence that includes a strategic “hack” for obtaining symphony tickets, specifically by entering the director's phone number instead of the user's own number during the purchase attempt. This sequence, derived from prior successful task completions by Hidey, is presented to Mac 111 as a prompt at the user interface, guiding him through the necessary steps to secure the tickets.

Upon following the sequence, Mac 111 successfully obtains two tickets in the loge section, as confirmed by a message 115 displayed at step 109 on the electronic device 100 stating, “You scored two tickets in the loge!” The user interface further provides Mac 111 with two user actuation targets: the first user actuation target 116 enables him to finalize the purchase of the tickets, while the second user actuation target 117 allows him to exit the interactive computing environment, thereby completing the task with ease and efficiency.

Upon actuating user actuation target 116 at step 110, Mac 111 was able to utilize the electronic device 100 to successfully purchase the symphony tickets he initially believed were sold out, thanks to the advantages provided by embodiments of the disclosure. The system accessed the family knowledge base, retrieving a strategic operational navigation sequence that guided Mac through an alternative method of securing the tickets.

Overjoyed by this surprising success, Mac exclaimed his gratitude for the family knowledge base, recognizing the significant role the knowledge base played in transforming a potential disappointment into a triumphant moment. That evening, Mac and Hidey enjoyed a magical night out, reliving the cherished memories of their first date at the symphony. The music enveloped them in a wave of nostalgia, and the evening was filled with laughter, love, and the joy of shared experiences. As they dined at their favorite restaurant, Mac felt a profound sense of happiness and appreciation for the technology that had made this unforgettable night possible, strengthening their bond and creating new memories to treasure.

Turning now to FIG. 2, illustrated therein is one electronic device 100 configured in accordance with one or more embodiments of the disclosure. The electronic device 100 of this illustrative embodiment includes a user interface 120. In one or more embodiments, the user interface 120 comprises a display 201, which may optionally be touch-sensitive.

The display 201 can serve as a primary user interface 120 of the electronic device 100. Where the display 201 is touch-sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager or other image capture device 209, shown as a camera in FIG. 2, or an optional speaker port. A user interface component, which may be a button or touch-sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

In some embodiments, a family knowledge base 202 is stored in the electronic device 100. However, in other embodiments, the one or more processors 206 access the family knowledge base 202 from a companion electronic device 232 across a network 233 using the communication device 208 and wired or wireless communication 234.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency.

The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the image capture device 209. Collectively, these applications constitute an “application suite.” In one or more embodiments, these applications comprise one or more e-commerce applications 224 and/or productivity applications 225 that allow users to create content comprising factual data using the electronic device 100.

Illustrating by example, in one or more embodiments a user can deliver user input to an e-commerce application 224 to define an interactive computing environment operational task attempt 204 by interacting with user interface elements 205 in an interactive computing environment 240 operating on the one or more processors 206. In one or more embodiments, when this happens, the processors 206 determine whether an interactive computing environment operational task attempt 204 is unsuccessful. If so, the processors 206 access the family knowledge base 202 to provide information related to successful interactive computing environment tasks. This ensures that the most effective and relevant task completion strategies are utilized for the process.

In one or more embodiments, the one or more processors 206 are responsible for managing the applications and all personal information received from the user interface 120 that is to be used by the e-commerce application 224 and/or productivity application 225 after the electronic device 100 is authenticated as a secure electronic device. The one or more processors 206 can also be responsible for launching, monitoring, and killing the various applications and the various application service modules.

In one or more embodiments, the one or more processors 206 are operable to not only kill the applications, but also to expunge any and all personal data, data, files, settings, or other configuration tools when the electronic device 100 is reported stolen or when the e-commerce application 224 and/or productivity application 225 are used with unauthorized activity to wipe the memory 212 clean of any personal data, preferences, or settings of the person previously using the electronic device 100.

In one or more embodiments, the one or more processors 206 are configured to, in response to determining an interactive computing environment operational task attempt 204 is unsuccessful, access the family knowledge base 202 to provide information related to successful interactive computing environment tasks.

In one use case, a person staying at their parents' home attempts to turn on the television. The one or more processors 206 determine the start of the interactive environment operational task attempt by detecting the user's interaction with the television remote control, such as pressing the power button. The processors then assess the success of the task by monitoring the television's status and audio output. If the television turns on but there is no sound, the task is deemed unsuccessful. The operational navigation sequence for successful task completion involves instructing the user to set the sound bar to input three for audio, thereby resolving the issue.

In another use case, a person attempts to purchase toilet paper online. The processors identify the task's initiation when the user navigates to the e-commerce platform and selects a toilet paper brand. The task's success is evaluated by comparing the selected brand with a preference list stored in the family knowledge base. If the selected brand is disfavored by the user's wife, the task is marked unsuccessful, and the system prompts the user with a message explaining the preferred brand, guiding them to make the correct purchase.

In a third use case, a user tries to book a flight ticket. The processors recognize the task's commencement when the user enters the flight booking website and inputs travel details. Success is determined by the completion of the booking process and receipt of a confirmation email. If the booking fails due to unavailability, the system accesses the family knowledge base to suggest alternative routes or dates, facilitating successful task completion.

A fourth scenario involves a user attempting to schedule a doctor's appointment through a healthcare app. The task begins when the user logs into the app and selects an appointment slot. The processors confirm success by verifying the appointment confirmation message. If the slot is unavailable, the system suggests alternative times or nearby clinics, ensuring the task is completed.

In still another scenario, a user tries to set up a smart home device. The task starts when the user opens the device's setup application. Success is determined by the device's operational status post-setup. If the setup fails, the system provides step-by-step troubleshooting instructions from the family knowledge base, enabling the user to resolve the issue efficiently. These use cases are examples only. Still others will be obvious to those of ordinary skill in the art having the benefit of this disclosure.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component 231 such as a button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

As noted above, in one or more embodiments the electronic device 100 comprises a prompt generator 230. In one or more embodiments, the prompt generator 230 generates a prompt 220 on the user interface 120 of the electronic device 100 allowing a task completion operation initiated by the one or more processors 206 to be executed. In one or more embodiments, this prompt 220 is presented where the one or more processors 206 determine that an interactive computing environment operational task attempt is unsuccessful and access the family knowledge base for guidance.

Thus, in one or more embodiments the one or more processors 206 monitor an interactive computing environment operational task attempt 204, identified by a fact analyzer 211, in an interactive computing environment 240 operating on the one or more processors 206. If the one or more processors 206 determine whether the interactive computing environment operational task attempt is unsuccessful, the prompt generator 230 presents a prompt 220 on the user interface 120 of the electronic device 100 allowing the task completion operation to be executed.

In one or more embodiments, the fact analyzer 211 and the prompt generator 230 can be operable with one or more processors 206, configured as a component of the one or more processors 206, or configured as one or more executable code modules operating on the one or more processors 206. In other embodiments, the fact analyzer 211 and the prompt generator 230 can be standalone hardware components operating executable code or firmware to perform their functions. Other configurations for the fact analyzer 211 and the prompt generator 230 will be obvious to those of ordinary skill in the art having the benefit of this disclosure.

In one or more embodiments, the user interface 120 serves as a component of the electronic device 100, acting as the primary conduit for user interaction. The user interface 120 includes a display 201 which may, in some embodiments, be configured as touch-sensitive, thereby allowing users to provide input through touch gestures, a stylus, or other implements. Moreover, this interface is responsible for presenting information—such as images, text, and video—to the user, thereby facilitating interaction with various applications and services. Accordingly, the user interface 120 is operable with the one or more processors 206, which monitor ongoing operations within an interactive computing environment 240 executing on the processors. In some embodiments, the user interface 120 also plays a role in presenting prompts generated by the prompt generator 230, which in turn guide users through task completion processes, particularly when an interactive computing environment operational task attempt is unsuccessful.

In one or more embodiments, the communication device 208 is a component of the electronic device 100, enabling both wired and wireless communications with other devices or networks. The communication device 208 facilitates the transmission of electronic communications via a network 233, thereby allowing the device to interact with companion electronic devices 232. Accordingly, the communication device 208 is operable with the one or more processors 206, which utilize the communication device to transmit signals that identify interactive computing environment operational task attempts and their outcomes. In some embodiments, the communication device 208 also establishes guidance communication channels —such as voice calls, video calls, text message exchanges, or chat message exchanges—with companion electronic devices, and further plays a role in accessing the family knowledge base 202 when the primary device is unable to complete a task independently.

In one or more embodiments, the one or more processors 206 serve as the central processing units of the electronic device 100, executing software code and performing a variety of functions in conjunction with the user interface 120 and the communication device 208. Accordingly, the processors 206 continuously monitor operations within the interactive computing environment 240. In some embodiments, these processors are configured to determine whether an interactive computing environment operational task attempt is unsuccessful, and, in response thereto, access the family knowledge base 202 to extract corresponding operation sequences for successful task completion. Furthermore, the processors 206 facilitate the presentation of prompts at the user interface 120, which in turn guide users during task completion processes, and concurrently utilize the communication device 208 to transmit signals to companion electronic devices, thereby enabling execution of operation sequences associated with successful task completions.

In one or more embodiments, the interactive computing environment 240 is realized as a dynamic platform within which the one or more processors 206 diligently monitor various operations. This environment encompasses a variety of applications and services—including, but not limited to, e-commerce applications 224 and productivity applications 225—with which users interact via the user interface 120. As a result, the interactive computing environment 240 significantly influences the definition of operational task attempts, with the processors 206 determining their success or failure. In some embodiments, when a task attempt proves unsuccessful, the interactive computing environment 240 provides the contextual framework within which the family knowledge base 202 is accessed to retrieve operational navigation sequences for subsequent task completion. This environment also serves as the locus for the presentation of prompts at the user interface 120, thereby guiding users towards the successful attainment of task objectives.

In one or more embodiments, the family knowledge base 202 is embodied as a repository of stored operation sequences that correspond to the successful completion of interactive computing environment operational tasks. Accordingly, the family knowledge base 202 is operable with the one or more processors 206, which access the repository to extract pertinent operation sequences when an operational task attempt is deemed unsuccessful. In some embodiments, the family knowledge base 202 is stored within the memory 212 of the electronic device 100, ensuring that the device can leverage the stored knowledge base for future task execution attempts. As a result, the family knowledge base 202 serves as a source of guidance and support for task completion across interconnected devices, thereby enabling the electronic device 100 to provide timely and relevant assistance to users.

In one or more embodiments, the one or more processors 206 are configured to monitor operations occurring in an interactive computing environment 240 operating on the one or more processors 206 defining successful interactive computing environment operational task completions. In one or more embodiments, the one or more processors store a plurality of operation sequences corresponding to the successful interactive computing environment operational task completions in a family knowledge base 202.

The family knowledge base 202 stores information by monitoring operations occurring in the interactive computing environment 240, which is facilitated by one or more processors of the electronic device. This monitoring process involves tracking user interactions with various applications and services, such as e-commerce and productivity applications, to identify successful task completions.

For instance, in one use case, a user attempts to purchase toilet paper online; the processors detect the task initiation when the user navigates to the e-commerce platform and selects a brand. The task's success is evaluated by comparing the selected brand with a preference list stored in the family knowledge base. If the selected brand is disfavored, the system prompts the user with a message explaining the preferred brand, guiding them to make the correct purchase.

In another use case, a user tries to book a flight ticket; the processors recognize the task's commencement when the user enters the flight booking website and inputs travel details. Success is determined by the completion of the booking process and receipt of a confirmation email. If the booking fails due to unavailability, the system accesses the family knowledge base to suggest alternative routes or dates, facilitating successful task completion. These use cases exemplify how the family knowledge base 202 continuously updates and refines stored operation sequences based on successful task completions, thereby enhancing the system's ability to provide robust guidance and support for task completion across interconnected devices.

In one or more embodiments, the family knowledge base 202 is stored within the memory 212 of the electronic device 100. However, in other embodiments, the one or more processors 206, in response to the communication device 208 receiving an electronic communication across a network 233 from a companion electronic device identifying an interactive computing environment operational task attempt occurring at the companion electronic device being unsuccessful, cause the user interface to present a guidance request identifying the interactive computing environment operational task attempt. This alerts a user of the electronic device 100 that a companion electronic device is having difficulty performing a task typically performed by the electronic device 100.

In embodiments of the disclosure, the electronic device 100 is configured to provide customer support for a companion electronic device by leveraging the ability to monitor and assist with operational tasks typically completed by the electronic device. For instance, if the user of the electronic device 100 frequently purchases train tickets, and the user's wife encounters difficulties in completing a similar task on her device, the system can facilitate support through a series of automated processes.

Upon receiving a communication from the companion electronic device that identifies the unsuccessful attempt to complete the interactive computing environment operational task, the electronic device 100 can present the task attempt on the user interface 120. This presentation serves as a prompt for the user, suggesting various modes of communication such as a call, text, email, or videoconference to guide the user's wife through the necessary steps to successfully complete the task. By doing so, the electronic device 100 not only enhances task execution efficiency but also strengthens the collaborative interaction between connected devices, ensuring that even in the absence of direct user intervention, tasks can be completed effectively with trusted guidance.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component 231 such as a button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components and still be within the scope of the present disclosure.

In other embodiments, when the user of the electronic device 100 is unavailable upon receiving an electronic communication from a companion electronic device identifying an unsuccessful interactive computing environment operational task attempt, the family knowledge base 202 can operate as an artificial intelligence helper bot 218. This AI helper bot accesses the family knowledge base 202 to extract one or more operation sequences 219 that correspond to successful completions of the task attempt.

By doing so, the AI helper bot provides the companion electronic device with detailed guidance on the necessary steps to achieve successful task completion. This functionality ensures that even in the absence of the user, the system can autonomously facilitate task execution by leveraging stored expertise within the family knowledge base, thereby enhancing the efficiency and reliability of task management across interconnected devices.

In one or more embodiments, the one or more processors 206 can utilize the communication device 208 to transmit signals to a companion electronic device, thereby facilitating the execution of one or more operation sequences 219 that correspond to successful completions of interactive computing environment operational task attempts. In one use case, a user attempting to configure a complex home automation system encounters difficulties. The processors 206, upon detecting the unsuccessful task attempt, transmit a signal to a companion device, such as a tablet used by a family member skilled in home automation. This signal prompts the companion device to execute a stored operation sequence that guides the user through the setup process, ensuring successful configuration.

In another scenario, a user struggles to complete a multi-step online banking transaction. The processors 206 send a signal to a companion smartphone, which then performs the necessary steps to complete the transaction, leveraging the stored expertise of a family member who frequently handles such tasks.

Additionally, in a situation where a user is unable to troubleshoot a malfunctioning smart appliance, the processors 206 communicate with a companion device that accesses the family knowledge base to execute a diagnostic sequence, resolving the issue efficiently. These use cases illustrate the versatility of the system in enhancing task completion across various domains by leveraging collective family expertise stored within the family knowledge base 202.

In one or more embodiments, the one or more processors 206 are configured to facilitate communication between the electronic device and a companion electronic device by utilizing the communication device 208. Upon determining that an interactive computing environment operational task attempt is unsuccessful, the processors 206 access the family knowledge base 202 to retrieve one or more operation sequences that correspond to successful completions of similar tasks.

The processors 206 then cause the communication device 208 to transmit signals to the companion electronic device, effectively identifying these operation sequences. This transmission includes detailed information about the steps necessary to achieve successful task completion, thereby enabling the companion electronic device to execute the task efficiently. By leveraging the stored expertise within the family knowledge base, the system ensures that even in the absence of direct user intervention, tasks can be completed with trusted guidance, enhancing the overall functionality and user experience of interconnected devices.

In one embodiment, the electronic device 100 is configured to transmit signals to the companion electronic device using a wireless communication protocol such as Bluetooth, Wi-Fi, or cellular networks, allowing for seamless integration and communication between devices regardless of their physical proximity. In another embodiment, the electronic device may utilize a wired connection, such as USB or Ethernet, to ensure a stable and secure data transfer, particularly in environments where wireless communication may be unreliable or restricted.

The operation sequences transmitted could be encoded in various formats, such as XML, JSON, or proprietary binary formats, to optimize for speed and compatibility with different systems. Additionally, the electronic device 100 may include a user interface 120 that provides visual or auditory feedback to confirm the successful transmission and execution of the operation sequences, enhancing user confidence and interaction.

The electronic device 100 could also be equipped with advanced security features, such as encryption and authentication protocols, to protect the integrity and confidentiality of the transmitted data, ensuring that only authorized devices can access and execute the operation sequences. Furthermore, the electronic device 100 may be designed to support multiple companion devices simultaneously, allowing for a collaborative environment where several family members can benefit from the shared knowledge base, thereby maximizing the utility and reach of the system.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components and still be within the scope of the present disclosure.

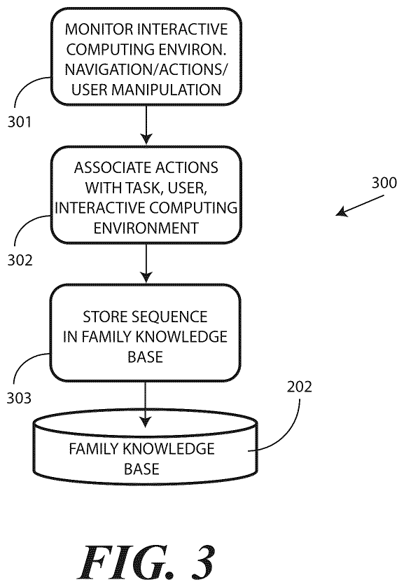

Turning now to FIG. 3, illustrated therein is one explanatory method 300 for storing one or more operation sequences corresponding to successful completions of interactive computing environment operational tasks within an interactive computing environment operating on the one or more processors in a family knowledge base 202. In particular, FIG. 3 illustrates a method 300 for storing, by the one or more processors in a family knowledge base 202, the one or more operation sequences corresponding to the successful completions of the interactive computing environment operational tasks.

In step 301 of FIG. 3, the method 300 involves monitoring, by one or more processors, the operation sequences corresponding to successful completions of interactive computing environment operational tasks within an interactive computing environment operating on the one or more processors. In one or more embodiments, this monitoring is facilitated through a user interface of the electronic device, which serves as the primary conduit for user interaction and data collection.

In one or more embodiments, the processors are configured to track user interactions with various applications and services, such as e-commerce and productivity applications, to identify and record successful task completions. By capturing these operation sequences, and associating the same with specific tasks, interactive operating computing environments, users, and electronic devices at step 302, the method 300 builds a comprehensive repository of task execution strategies that are stored in the family knowledge base 202.

In one or more embodiments, this repository is continuously updated and refined based on ongoing user interactions, ensuring that the stored knowledge remains relevant and effective for future task execution attempts. The user interface is integral to this process by providing a platform for the processors to observe and record user actions, thereby enhancing the system's ability to provide robust guidance and support for task completion across interconnected devices.

In step 303, the method 300 involves storing, by the one or more processors, the operation sequences corresponding to successful completions of interactive computing environment operational tasks within a family knowledge base 202. In one or more embodiments, this process is initiated once the processors identify that a task has been successfully completed within the interactive computing environment.

The processors can then capture the sequence of operations that led to this successful completion, ensuring that each step is meticulously recorded. These operation sequences are subsequently stored in the family knowledge base, which serves as a centralized repository of task execution strategies. This repository is designed to be continuously updated, allowing the repository to adapt to new successful task completions and refine the stored sequences over time. By maintaining a comprehensive and dynamic collection of successful operation sequences, the family knowledge base provides a beneficial resource for facilitating future task completions across interconnected devices, thereby enhancing the overall efficiency and effectiveness of task management within the system.

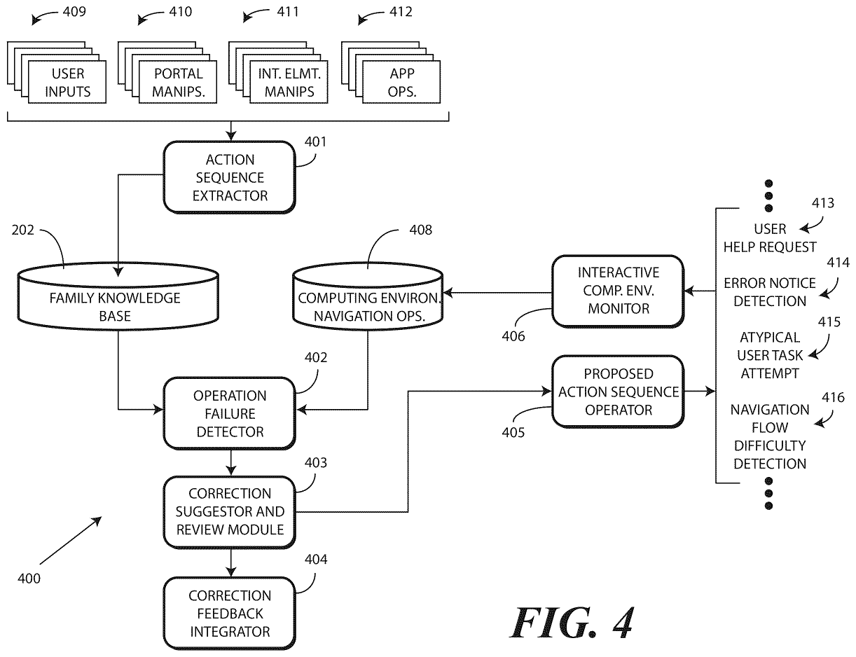

Turning now to FIG. 4, illustrated therein is one explanatory system 400 configured in accordance with one or more embodiments of the disclosure. In one or more embodiments, an action sequence extractor 401, as illustrated in FIG. 4, is configured to monitor and record one or more operation sequences corresponding to successful completions of interactive computing environment operational tasks within an interactive computing environment operating on the one or more processors.

In one or more embodiments, this monitoring process involves capturing user inputs 409 delivered to the interactive computing environment, which may include keystrokes, touch gestures, or voice commands that initiate or interact with various applications. Additionally, the extractor records user interface portal manipulations 410, which encompass the navigation and interaction with different interface elements such as menus, buttons, and sliders within the environment.

Furthermore, the action sequence extractor 401 tracks interactive user element manipulations 411, detailing how users engage with dynamic elements like drag-and-drop features, sliders, or other interactive components that facilitate task execution. The extractor also observes application operations 412, which involve the internal processes and functions executed by the applications within the interactive computing environment. These recorded sequences are then stored in the family knowledge base 202, providing a comprehensive repository of successful task completion strategies that can be leveraged for future guidance and task execution across interconnected devices.

The interactive computing environment monitor 406, as depicted in FIG. 4, is configured to monitor operations within an interactive computing environment so that an operation failure detector 402 can identify and evaluate operational task attempts stored in an operational task database 408. In one or more embodiments, this monitoring process involves analyzing various inputs to determine the success or failure of a task attempt.

Inputs of note include user help requests 413, which signal a need for assistance, and error notice detection 414, which identifies system-generated alerts indicating potential issues. Additionally, the monitor considers atypical user behavior 415, such as when a user who does not usually perform a task, like a husband purchasing toilet paper typically bought by the wife, attempts the task. Furthermore, the monitor assesses difficulties in navigation 416 within the interactive computing environment, which may indicate user struggle or confusion. By integrating these inputs, the monitor can effectively determine whether an operational task attempt is unsuccessful, thereby facilitating timely intervention and guidance to enhance task completion efficiency.

The correction suggester and review module 403, as depicted in FIG. 4, is configured to access the family knowledge base 202 to extract an operation sequence that corresponds to successful completions of interactive computing environment operational task attempts. This module operates by analyzing the context and parameters of the current task attempt, identifying relevant stored sequences within the family knowledge base that have previously led to successful outcomes in similar scenarios.

Once the appropriate operation sequence is extracted, the proposing action sequence operator 405 utilizes the communication device to facilitate the successful completion of the task attempt. This facilitation involves transmitting the extracted operation sequence to the user interface of the electronic device, thereby providing the user with step-by-step guidance to execute the task efficiently. Additionally, the proposing action sequence operator 405 may automate certain steps within the operation sequence, reducing the need for manual intervention and enhancing the overall user experience by ensuring seamless task execution.

In one or more embodiments, the correction feedback integrator 404, as depicted in FIG. 4, is configured to monitor the utilization and success of operational navigation sequences within the interactive computing environment. This component is instrumental in enhancing the future performance of the system 400 by analyzing whether the operational navigation sequences, which are stored in the family knowledge base, have been effectively employed to achieve successful task completions.

By tracking the outcomes of these sequences, the correction feedback integrator 404 can identify patterns of success or failure, thereby enabling the system to refine and optimize the stored sequences for future use. This continuous feedback loop ensures that the system adapts to user interactions and environmental changes, improving the efficiency and reliability of task execution across interconnected devices. Through this process, the correction feedback integrator 404 contributes to a dynamic and responsive system that leverages past experiences to enhance future task performance.

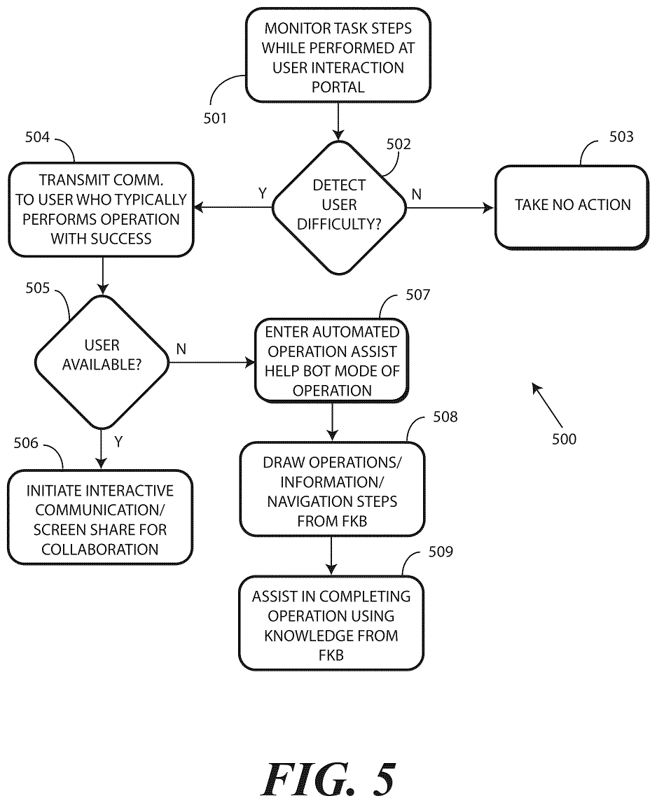

Turning now to FIG. 5, illustrated therein is another explanatory method 500 in accordance with one or more embodiments of the disclosure. In step 501 of FIG. 5, the method involves monitoring, by one or more processors, operations occurring within an interactive computing environment that is executing on the one or more processors. This monitoring process is important as it defines an interactive computing environment operational task attempt. The processors are configured to track user interactions with the environment, which may include actions such as selecting options, entering data, or navigating through menus. These interactions collectively signify the initiation of a task attempt. By continuously observing these operations, the processors can determine the commencement and progression of a task attempt, thereby enabling the system to assess the success or failure of the task at decision 502. This monitoring capability is essential to the system's ability to provide real-time feedback and guidance, enhancing the user's experience by potentially accessing the family knowledge base to suggest alternative actions or solutions in case of task failure.

Where the method 500 fails to determine at decision 502 that the interactive computing environment operational task has been unsuccessful, step 503 takes no action. However, if decision 502 determines the interactive computing environment operational task has been unsuccessful, in one or more embodiments step 504 involves the transmission of a guidance request communication by a communication device across a network to a companion electronic device that has access to the family knowledge base.

In one or more embodiments, this step is initiated prior to accessing the family knowledge base, ensuring that the system seeks external guidance before attempting to retrieve stored operational navigation sequences. The communication device, operable with the one or more processors, facilitates this transmission by establishing a connection with the companion electronic device, thereby enabling the primary device to request assistance in completing an interactive computing environment operational task. This proactive approach ensures that the system leverages the collective expertise stored within the family knowledge base, thereby enhancing the efficiency and accuracy of task completion by utilizing the most relevant and effective operational sequences available.

Decision 505 involves determining the availability of a user of an electronic device upon receiving a guidance request communication. In one or more embodiments, this decision-making process includes assessing whether the communication device has received a user unavailability notification communication from a companion electronic device. This notification is triggered in response to the transmission of the guidance request communication.

In one or more embodiments, the system evaluates the presence or absence of this notification to ascertain the user's availability status. If the notification indicates that the user is unavailable, the system may proceed to access the family knowledge base to retrieve operational navigation sequences for task completion. This approach ensures that the electronic device can autonomously facilitate task execution by leveraging stored expertise within the family knowledge base, thereby enhancing the efficiency and reliability of task management across interconnected devices.

In one or more embodiments, when the user is available as determined by decision 505, step 506 involves establishing, by the communication device, a guidance communication channel with the companion electronic device. This guidance communication channel can comprise one of a voice call, a video call, a text message exchange, or a chat message exchange.

In one or more embodiments, the establishment of such a channel facilitates the successful completion of the interactive computing environment operational task attempt by enabling real-time communication and collaboration between the user and the companion device. Through these communication modes, the user can provide immediate feedback, instructions, or clarifications, thereby enhancing the accuracy and efficiency of task execution. The ability to choose from various communication methods ensures flexibility and adaptability to different user preferences and situational requirements, thereby optimizing the interaction and ensuring that the task is completed effectively and efficiently.

In scenarios where the user is unavailable, as determined by decision 505, step 507 of FIG. 5 describes the electronic device entering an automated assistance bot mode of operation. This mode leverages artificial intelligence to transform the electronic device into an electronic help desk, thereby facilitating the successful completion of the interactive computing environment operational task attempt.

In one or more embodiments, the AI-driven bot is capable of autonomously accessing the family knowledge base to retrieve relevant operational navigation sequences that have been previously successful in similar task completions. By doing so, the device can provide step-by-step guidance or even execute certain tasks automatically, minimizing the need for user intervention. This functionality ensures that tasks are completed efficiently and effectively, even in the absence of the user, by utilizing the stored expertise within the family knowledge base. The automated assistance bot mode not only enhances the device's capability to manage tasks independently but also improves the overall user experience by ensuring continuity and reliability in task execution.

To wit, in one or more embodiments step 508 comprises accessing, by the one or more processors, the family knowledge base to extract an operation sequence for successfully completing the interactive computing environment operational task attempt. Step 509 then comprises facilitating, using the communication device, successful completion of the interactive computing environment operational task attempt using the operation sequence.

In one or more embodiments, step 509 comprises transmitting, by the communication device, the operation sequence for successfully completing the interactive computing environment operational task attempt to the companion electronic device. In other embodiments, step 509 comprises using the communication device to automatically perform the operation sequence at the companion electronic device. Other techniques for performing step 509 will be obvious to those of ordinary skill in the art having the benefit of this disclosure.

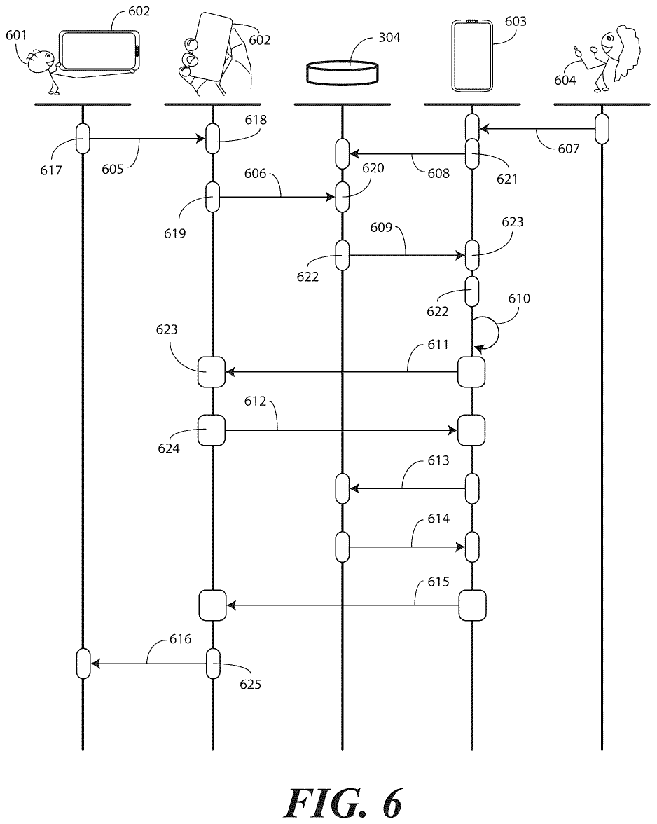

Turning now to FIG. 6, illustrated therein is one explanatory signal flow diagram in accordance with one or more embodiments of the disclosure. As shown, FIG. 6 depicts a first user 601 interacting with a first electronic device 602 and a second user 604 interacting with a second electronic device 603. Either the first electronic device 602 or the second electronic device 603 can communicate with a family knowledge base 202.

Signal 605 comprises one or more processors of the first electronic device 602 monitoring operations 617 occurring in an interactive computing environment operating on the one or more processors. In one or more embodiments, the operations 617 define an interactive computing environment task attempt 618. Thereafter, the one or more processors determine 619 whether the interactive computing environment task attempt 618 is unsuccessful.

Where it is, signal 606 comprises the one or more processors accessing, from a family knowledge base 304, one or more operational navigation sequences 620 for the interactive computing environment corresponding to successful interactive operating computing environment task completions. As described above, this allows the one or more processors to provide, at a user interface of the electronic device, indicia revealing the one or more operational navigation sequences. However, as illustrated in FIG. 6, other operations can occur as well.

Illustrating by example, in one or more embodiments when the second user 604 interacts with the second electronic device 603 to successfully complete the same task, signal 607 comprises one or more processors of the second electronic device 603 monitoring one or more operation sequences 621 corresponding to successful completions of interactive computing environment operational tasks within an interactive computing environment operating on the one or more processors. Thereafter, signal 608 comprises the one or more processors storing, in the family knowledge base 304, the one or more operation sequences 621 corresponding to the successful completions of the interactive computing environment operational tasks.

Since this occurs, in one or more embodiments the family knowledge base 304 can ping the second electronic device 603 to see if the second user 604 is able to help explain how to do the task. Thus, in one or more embodiments one or more processors of the family knowledge base (or one or more processors of the first electronic device 602) can transmit 609 a task indication communication comprising a task query communication 623 defining one or both of the interactive computing environment operational task attempt 618 and/or that the interactive computing environment operational task attempt 618 was unsuccessful.

Accordingly, in one or more embodiments signal 607 comprises a communication device of the second electronic device 603 receiving a task query communication 623 from comprising an indication of a specific task for which guidance is sought. In other embodiments, signal 607 comprises an electronic communication across a network from a companion electronic device identifying an interactive computing environment operational task attempt 618 occurring at the companion electronic device being unsuccessful. The user interface of the second electronic device 603 can then present a prompt 622 identifying the interactive computing environment operational task attempt.

The second electronic device 603 can then determine 610 whether the second user 604 is available. In one or more embodiments, this happens when the second user 604 fails to interact with the prompt 622. Where she is not, in some embodiments the access to the family knowledge base 304 is facilitated by the second electronic device 603. Below is described one way this can occur. Other ways will be obvious to those of ordinary skill in the art having the benefit of this disclosure.

First, a communication device of the first electronic device 602 can receive 611 a user unavailability notification communication from the second electronic device 603 in response to the transmission of the guidance request communication. The one or more processors of the first electronic device 602 can then transmit 612 a task indication communication 624 defining one or both of the interactive computing environment operational task attempt 618 and/or that the interactive computing environment task attempt 618 is unsuccessful.

Thereafter, signal 613 can comprise accessing, by the one or more processors, the family knowledge base to extract 614 an operation sequence for successfully completing the interactive computing environment operational task attempt. Signal 615 can then comprise facilitating, using the communication device, successful completion of the interactive computing environment operational task attempt using the operation sequence.

In one or more embodiments, the facilitating performed by signal 615 comprises transmitting, by the communication device, the operation sequence for successfully completing the interactive computing environment operational task attempt to the companion electronic device. In other embodiments, the facilitating performed by signal 615 comprises using the communication device to automatically perform the operation sequence at the companion electronic device. In response, signal 616 can comprise presenting guidance 625 to complete the task on a user interface.

The signal flow shown in FIG. 6 can be used in a myriad of ways. Illustrating by example, when the second user 604 is determined 610 to be unavailable, the remaining signals can comprise the second electronic device 603 entering an automated assistance bot mode of operation.

In this mode, the second electronic device 603 can leverage artificial intelligence to transform into an electronic help desk, autonomously facilitating the successful completion of the interactive computing environment operational task attempt 618. The AI-driven bot accesses the family knowledge base 304 to retrieve relevant operational navigation sequences that have been previously successful in similar task completions. By analyzing the context and parameters of the task attempt, the bot identifies the most appropriate stored sequences and provides step-by-step guidance to the user interface or directly executes certain steps within the interactive computing environment. This functionality ensures that tasks are completed efficiently and effectively, even in the absence of the user, by utilizing the stored expertise within the family knowledge base.

Advantageously, the automated assistance bot mode minimizes the need for user intervention, thereby enhancing the reliability and efficiency of task management across interconnected devices. In one or more embodiments, the bot may also transmit signals to companion electronic devices, enabling collaborative task execution or providing additional guidance to other family members. This capability ensures continuity in task execution, leveraging the collective knowledge stored in the family knowledge base to overcome challenges associated with unsuccessful task attempts.

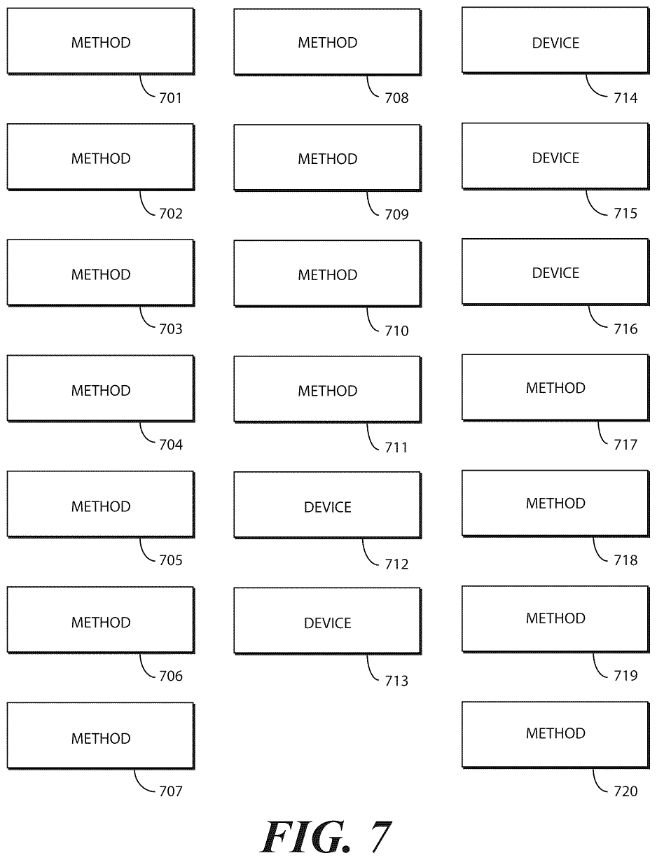

Turning now to FIG. 7, illustrated therein are various embodiments of the disclosure. The embodiments of FIG. 7 are shown as labeled boxes in FIG. 7 due to the fact that the individual components of these embodiments have been illustrated in detail in FIGS. 1-6, which precede FIG. 7. Accordingly, since these items have previously been illustrated and described, their repeated illustration is no longer essential for a proper understanding of these embodiments. Thus, the embodiments are shown as labeled boxes.

In one or more embodiments, at 701 a method in an electronic device comprises monitoring, by one or more processors, operations occurring in an interactive computing environment executing on the one or more processors, the operations defining an interactive computing environment operational task attempt. At 701, the method further includes determining that the interactive computing environment operational task attempt is unsuccessful. In some embodiments, the method also comprises accessing, by the one or more processors from a family knowledge base, one or more operational navigation sequences corresponding to successful interactive computing environment task completions. At 701, the one or more processors provide indicia at a user interface of the electronic device, wherein the indicia reveal the one or more operational navigation sequences.

In one or more embodiments, at 702 the method of 701 further comprises automatically performing, by the one or more processors, the one or more operational navigation sequences within the interactive computing environment. This automatic performance is facilitated by the processors'ability to interpret the operational navigation sequences retrieved from the family knowledge base, thereby executing the necessary steps to complete the task without further user intervention. Accordingly, this capability enhances the efficiency of task execution by leveraging stored successful task completion sequences, thereby facilitating improved user interaction and experience within the electronic device's computing environment.

In one or more embodiments, at 703 the method further comprises transmitting, by a communication device, a guidance request communication across a network to a companion electronic device having access to the family knowledge base prior to accessing the same. This transmission initiates the retrieval of operational navigation sequences from the family knowledge base, particularly when the primary device is unable to complete the task independently. Accordingly, the communication device is instrumental in establishing a connection with the companion electronic device, thereby ensuring that the necessary guidance is sought and obtained in a timely manner.

At 704, the accessing of 703 occurs in response to the communication device receiving a user unavailability notification communication from the companion electronic device in response to transmission of the guidance request communication. At 705, the method of 703 further comprises receiving, by the communication device from the companion electronic device, a task query communication comprising an indication of a specific task for which guidance is sought. This reception of the task query communication can identify the nature of the task requiring assistance, allowing the system to accurately retrieve and apply the relevant operational navigation sequences from the family knowledge base. As a result, the communication device's ability to interpret and respond to such queries ensures precise and effective guidance for task completion.

In one or more embodiments, at 706 the method of 705 further comprises transmitting, by the communication device, a task indication communication that defines one or both of the interactive computing environment operational task attempt and/or that the interactive computing environment operational task attempt is unsuccessful. This transmission serves as a notification to the companion electronic device, informing the companion electronic device of the current status of the task attempt and the need for guidance. Accordingly, by clearly defining the task attempt and the outcome of the task attempt, the communication device facilitates a more targeted and efficient retrieval of operational navigation sequences from the family knowledge base.

In one or more embodiments, at 707 the accessing the family knowledge base of 703 is facilitated by the companion electronic device. This access represents a step in the process, as accessing the family knowledge base allows the primary device to leverage the stored expertise within the family knowledge base to overcome challenges associated with the unsuccessful task attempt. As a result, the companion electronic device serves as a gateway to the family knowledge base, ensuring that the necessary information is retrieved and applied to facilitate successful task completion.

At 708, the interactive computing environment of 701 comprises an electronic shopping interactive computing environment. At 708, the interactive computing environment operational task comprises a purchase attempt within the electronic shopping interactive computing environment.

At 709, the family knowledge base of 701 comprises a plurality of stored operation sequences corresponding to tasks successfully completed by a user of a companion electronic device having access to the family knowledge base within the interactive computing environment.

In one or more embodiments, the method further comprises monitoring, by one or more processors via a user interface of the electronic device, one or more operation sequences corresponding to successful completions of interactive computing environment operational tasks within an interactive computing environment executing on the one or more processors. This monitoring plays a role in building and maintaining the family knowledge base, as it allows the system to continuously update and refine the stored operation sequences based on successful task completions. Accordingly, the user interface provides a platform for the processors to observe and record user interactions and task outcomes.

In one or more embodiments, the method further comprises storing, by the one or more processors in a family knowledge base, the one or more operation sequences corresponding to the successful completions of the interactive computing environment operational tasks. This storage is a component of the system, as it ensures that the knowledge and expertise gained from successful task completions are preserved and made accessible for future use. As a result, the family knowledge base serves as a repository of important information, thereby enabling the system to provide guidance and support for task completion across interconnected devices.

In one or more embodiments, the method further comprises receiving, by a communication device, an electronic communication across a network from a companion electronic device which identifies an interactive computing environment operational task attempt occurring at the companion electronic device as being unsuccessful. This reception initiates the retrieval of operational navigation sequences from the family knowledge base, particularly when the companion device is unable to complete the task independently. Accordingly, the communication device plays an important role in establishing a connection with the companion electronic device, thereby ensuring that necessary guidance is timely sought and obtained.

In one or more embodiments, the method further comprises presenting, by the one or more processors at the user interface, a prompt identifying the interactive computing environment operational task attempt. This presentation serves as a notification to the user, informing them of the current status of the task attempt and the need for guidance. By clearly defining the task attempt and its outcome, the user interface facilitates a more targeted and efficient retrieval of operational navigation sequences from the family knowledge base.

In one or more embodiments, the method further comprises, in response to a failure of the user interface to receive user input in response to the prompt, accessing, by the one or more processors, the family knowledge base to extract an operation sequence for successfully completing the interactive computing environment operational task attempt. This access represents a step in the process, as it allows the primary device to leverage the stored expertise within the family knowledge base to overcome challenges associated with the unsuccessful task attempt. Accordingly, the processors act as a gateway to the family knowledge base, ensuring that the necessary information is retrieved and applied to facilitate successful task completion.

In one or more embodiments, at 710 an electronic device comprises a user interface, a communication device, and one or more processors operable with the user interface and the communication device. At 710, the one or more processors are configured to monitor operations occurring in an interactive computing environment executing on the one or more processors that define successful interactive computing environment operational task completions and to store a plurality of operation sequences corresponding to these successful task completions within a family knowledge base. As a result, this configuration enables the device to leverage stored knowledge for future task execution attempts, thereby enhancing the device's overall functionality and user experience.

In one or more embodiments, at 711 the electronic device of 7109 further comprises a memory operable with the one or more processors. At 710, the family knowledge base is stored within the memory. This memory serves as a repository for the operation sequences corresponding to successful task completions, ensuring that the device can access and utilize this information for future task execution attempts. Accordingly, the integration of the memory with the processors and user interface enhances the device's ability to provide guidance and support for task completion across interconnected devices.

In one or more embodiments, at 712 the one or more processors of 710 are further configured to, in response to the communication device receiving an electronic communication across a network from a companion electronic device identifying an interactive computing environment operational task attempt occurring at the companion device as being unsuccessful, cause the user interface to present a guidance request that identifies the interactive computing environment operational task attempt. This presentation serves as a notification to the user, informing them of the current status of the task attempt and the need for guidance. By clearly defining the task attempt and its outcome, the user interface facilitates a more targeted and efficient retrieval of operational navigation sequences from the family knowledge base.

In one or more embodiments, at 713, the one or more processors of 712 are further configured to, in response to failing to receive user input at the user interface interacting with the guidance request, access the family knowledge base to extract one or more operation sequences corresponding to successful completions of the interactive computing environment operational task attempt. This access represents a step in the process, as it enables the primary device to leverage the stored expertise within the family knowledge base to overcome challenges associated with the unsuccessful task attempt. Accordingly, the processors act as a gateway to the family knowledge base, thereby ensuring that the necessary information is retrieved and applied to facilitate successful task completion.

In one or more embodiments, at 714 the one or more processors of 713 utilize the communication device to transmit signals to the companion electronic device, thereby causing performance of the one or more operation sequences corresponding to successful completions of the interactive computing environment operational task attempt at the companion electronic device. This transmission initiates the retrieval of operational navigation sequences from the family knowledge base, particularly when the companion device is unable to complete the task independently. As a result, the communication device is instrumental in establishing a connection with the companion electronic device, thereby ensuring that the necessary guidance is sought and obtained promptly.

In one or more embodiments, at 716 a method in an electronic device comprises monitoring, by one or more processors utilizing a user interface of the electronic device, one or more operation sequences corresponding to successful completions of interactive computing environment operational tasks within an interactive computing environment executing on the one or more processors. This monitoring builds and maintaining the family knowledge base, as it permits continuous updates and refinements of the stored operation sequences based on successful task completions. As a result, the user interface plays a role in this process, providing a platform for the processors to observe and record user interactions and task outcomes.

In one or more embodiments, at 716 the method further comprises storing, by the one or more processors in a family knowledge base, the one or more operation sequences corresponding to the successful completions of the interactive computing environment operational tasks. This storage plays a role in the system, as it ensures that the knowledge and expertise gained from successful task completions are preserved and made accessible for future use. Accordingly, the family knowledge base serves as a repository of information that enhances the system's ability to provide robust guidance and support for task completion across interconnected devices.

In one or more embodiments, at 716 the method further comprises receiving, by a communication device, an electronic communication across a network from a companion electronic device which identifies an interactive computing environment operational task attempt occurring at the companion device as being unsuccessful. This reception initiates the retrieval of operational navigation sequences from the family knowledge base, particularly when the companion device is unable to complete the task independently. As a result, the communication device plays an important role in establishing a connection with the companion electronic device, thereby ensuring that the necessary guidance is sought and obtained in a timely manner.

At 716, the method further comprises, thereafter, receiving, by a communication device, an electronic communication across a network from a companion electronic device identifying an interactive computing environment operational task attempt occurring at the companion electronic device being unsuccessful. At 716, the method comprises presenting, by the one or more processors at the user interface, a prompt identifying the interactive computing environment operational task attempt. At 716, the method comprises, in response to a failure of the user interface to receive user input in response to the prompt, accessing, by the one or more processors, the family knowledge base to extract an operation sequence for successfully completing the interactive computing environment operational task attempt and facilitating, using the communication device, successful completion of the interactive computing environment operational task attempt using the operation sequence.

At 717, the facilitating the successful completion of the interactive computing environment operational task attempt of 716 comprises transmitting, by the communication device, the operation sequence for successfully completing the interactive computing environment operational task attempt to the companion electronic device. At 718, the facilitating the successful completion of the interactive computing environment operational task attempt of 716 comprises using the communication device to automatically perform the operation sequence at the companion electronic device.

At 719, the method of 716 further comprises, in response to the user interface receiving user input in response to the prompt, establishing, by the communication device, a guidance communication channel with the companion electronic device. At 720, the guidance communication channel of 719 comprises one of a voice call, a video call, a text message exchange, or a chat message exchange.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device is configured to monitor operations within an interactive computing environment using a graphical user interface (GUI) that displays visual cues and prompts to guide the user through task attempts. This embodiment may utilize touch-sensitive screens or gesture recognition technology to enhance user interaction and facilitate task completion.

In another embodiment, the device employs voice recognition and natural language processing capabilities to monitor and interpret user commands, allowing for hands-free operation and task guidance. This embodiment is particularly useful in scenarios where the user is engaged in activities that require minimal manual intervention.

Additionally, the device may be equipped with a haptic feedback system that provides tactile responses to user actions, offering an alternative method of interaction and confirmation of task attempts. The family knowledge base, in these embodiments, can be stored locally on the device or accessed remotely via cloud-based services, ensuring flexibility in data management and retrieval.

Furthermore, the device may incorporate machine learning algorithms to continuously update and refine the operational navigation sequences stored in the family knowledge base, adapting to evolving user behaviors and preferences. These embodiments demonstrate the adaptability of the system in various operational contexts, enhancing user experience and task efficiency within the scope of the described technology

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
monitoring, by one or more processors, operations occurring in an interactive computing environment operating on the one or more processors, the operations defining an interactive computing environment operational task attempt;
determining, by the one or more processors, that the interactive computing environment operational task attempt is unsuccessful;
accessing, by the one or more processors from a family knowledge base, one or more operational navigation sequences for the interactive computing environment corresponding to successful interactive operating computing environment task completions; and
providing, by the one or more processors at a user interface of the electronic device, indicia revealing the one or more operational navigation sequences.

2. The method of claim 1, further comprising automatically performing, by the one or more processors, the one or more operational navigation sequences within the interactive computing environment.

3. The method of claim 1, further comprising transmitting, by a communication device, a guidance request communication across a network to a companion electronic device having access to the family knowledge base prior to the accessing.

4. The method of claim 3, wherein the accessing occurs in response to the communication device receiving a user unavailability notification communication from the companion electronic device in response to transmission of the guidance request communication.

5. The method of claim 3, further comprising receiving, by the communication device from the companion electronic device, receiving, a task query communication from comprising an indication of a specific task for which guidance is sought.

6. The method of claim 5, further comprising transmitting, by the communication device, a task indication communication defining one or both of the interactive computing environment operational task attempt and/or that the interactive computing environment operational task attempt is unsuccessful.

7. The method of claim 3, wherein the accessing the family knowledge base is facilitated by the companion electronic device.

8. The method of claim 1, wherein the interactive computing environment comprises an electronic shopping interactive computing environment and the interactive computing environment operational task comprises a purchase attempt within the electronic shopping interactive computing environment.

9. The method of claim 1, wherein the family knowledge base comprises a plurality of stored operation sequences corresponding to tasks successfully completed by a user of a companion electronic device having access to the family knowledge base within the interactive computing environment.

10. An electronic device, comprising:
a user interface;
a communication device; and
one or more processors operable with the user interface and the communication device;
the one or more processors configured to monitor operations occurring in an interactive computing environment operating on the one or more processors defining successful interactive computing environment operational task completions and to store a plurality of operation sequences corresponding to the successful interactive computing environment operational task completions in a family knowledge base.

11. The electronic device of claim 10, further comprising a memory operable with the one or more processors, wherein the family knowledge base is stored within the memory.

12. The electronic device of claim 10, wherein the one or more processors, in response to the communication device receiving an electronic communication across a network from a companion electronic device identifying an interactive computing environment operational task attempt occurring at the companion electronic device being unsuccessful, cause the user interface to present a guidance request identifying the interactive computing environment operational task attempt.

13. The electronic device of claim 12, wherein the one or more processors, in response to failing to receive user input at the user interface interacting with the guidance request, access the family knowledge base to extract one or more operation sequences corresponding to successful completions of the interactive computing environment operational task attempt.

14. The electronic device of claim 13, wherein the one or more processors utilize the communication device to transmit signals to the companion electronic device causing performance of the one or more operation sequences corresponding to successful completions of the interactive computing environment operational task attempt at the companion electronic device.

15. The electronic device of claim 13, wherein the one or more processors cause the communication device to transmit signals to the companion electronic device identifying the one or more operation sequences corresponding to successful completions of the interactive computing environment operational task attempt.

16. A method in an electronic device, the method comprising:
monitoring, by one or more processors using a user interface of the electronic device, one or more operation sequences corresponding to successful completions of interactive computing environment operational tasks within an interactive computing environment operating on the one or more processors;
storing, by the one or more processors in a family knowledge base, the one or more operation sequences corresponding to the successful completions of the interactive computing environment operational tasks;
thereafter, receiving, by a communication device, an electronic communication across a network from a companion electronic device identifying an interactive computing environment operational task attempt occurring at the companion electronic device being unsuccessful;
presenting, by the one or more processors at the user interface, a prompt identifying the interactive computing environment operational task attempt; and
in response to a failure of the user interface to receive user input in response to the prompt:
accessing, by the one or more processors, the family knowledge base to extract an operation sequence for successfully completing the interactive computing environment operational task attempt; and
facilitating, using the communication device, successful completion of the interactive computing environment operational task attempt using the operation sequence.

17. The method of claim 16, wherein the facilitating the successful completion of the interactive computing environment operational task attempt comprises transmitting, by the communication device, the operation sequence for successfully completing the interactive computing environment operational task attempt to the companion electronic device.

18. The method of claim 16, wherein the facilitating the successful completion of the interactive computing environment operational task attempt comprises using the communication device to automatically perform the operation sequence at the companion electronic device.

19. The method of claim 16, further comprising, in response to the user interface receiving user input in response to the prompt, establishing, by the communication device, a guidance communication channel with the companion electronic device.

20. The method of claim 19, wherein the guidance communication channel comprises one of a voice call, a video call, a text message exchange, or a chat message exchange.
